(19) United States
(12) Patent Application Publication
(10) Pub. No.: US 2004/0117263 A1
(43) Pub. Date: Jun. 17, 2004

(54) Method, server system and computer program product for user registration and electronic commerce system

(76) Inventors: Michael Gieselmann, Hamein (DE); Tomas Iijort, Nurnberg (DE); Thomas Medved, Feucht (DE); Jurgen Plotz, Uttenreuth (DE)

Correspondence Address: STAAS & HALSEY LLP, SUITE 700, 1201 NEW YORK AVENUE, N.W., WASHINGTON, DC, 20005, US

(21) Appl. No.: 10/250,906

(22) PCT Filed: Apr. 1, 2002
(86) PCT No.: PCT/EP02/00044

(30) Foreign Application Priority Data
Jan. 8, 2001 (EP) 011004348

(51) Int. Cl. G06F 17/60

(52) U.S. Cl. 705/26

(57) ABSTRACT

A method and system for processing of application data for user registration of an on-line marketplace 5 is provided. The system requires an initial registration of a company and one of its' employees. The first registered user of the company is assigned an admin ID. Other employees of the comany i can submit applicatins indicating the admin ID. Such applications are stored in database 8 and an e-mail is sent to the administrator to notify him or her about receipt of additional applications. In response to this the administrator accesses the admin-tool 9 in order to process the applications.

The present invention generally relates to data processing methods for user registration and to electronic commerce systems and, more specifically, to a procurement system which enables a plurality of users within a purchasing organization to procure goods/services from an on-line marketplace.

Electronic shopping systems currently exist which allow users to remotely purchase goods and services from a variety of different on-line merchants over a distributed computer network such as the internet. With systems of this type, the on-line merchants typically publish on-line catalogues which can be viewed interactively by the end users on the network using a client computer, such as a PC. Such shopping systems exist for all kinds of market segments, including business to consumer and business to business markets.

U.S. Pat. No. 6,125,352 discloses a method for conducting commerce over a distributed network. A merchant site Web server provides HTML-coded Web documents which describe merchant products and which host computer-based shopping options. The HTML-coded Web documents contain function-calling information by which consumer-selected options invoke shopping-related functions on either the merchant (server) computer or the consumer (client) computer. A consumer selects the options from within the Web browser to initiate shopping-related operations such as: retrieve product information from merchants on the World Wide Web, selectively store product information locally on the consumer computer, locally compare product information from different merchants, locally store payment source and shipping address information and selectively forward such information to merchant sites, order products from Web-based merchants, track the status of purchase orders, and receive instructional information on application usage.

From U.S. Pat. No. 5,970,475 an electronic procurement system is known. The system enables corporate purchasers and suppliers to electronically transact for the purchase and supply of goods/services. The system includes three major hardware and software components: buyer, supplier and bank/administration. To enable suppliers to supply goods and services online and process electronic orders, several software components are used for operating a supplier processor server and a supplier catalog server. To enable corporate purchasers to purchase products and services online, preferably over the Internet, from suppliers, software is used for operating a customer server to which multiple users may log-on and access the supplier server.

One example of an on-line system for processing business transactions is disclosed in U.S. Pat. No. 4,799,156 for an Interactive Market Management System. The system discloses a plurality of buyers and a plurality of sellers which can be linked to each other by means of an interactive market management system (IMMS) for interactive communications. Each of the participating entities which is a subscriber to the system must always operate through the IMMS, which serves as a focal point or hub through which all transactions must be funneled. The patent does not address the need or ability of individuals within an organization to be provided with different levels of authorization.

In U.S. Pat. No. 5,557,518, a system is described for trusted agents for open electronic commerce. However, this patent involves the use of “money modules” to create a secure transaction environment for both the buyer and the seller of electronic merchandise and services. The primary objective of the patent is to provide a system which allows customers to buy electronic merchandise or services on demand without enrolling in an electronic community. According to this patent, a customer and supplier, trusted agent, establish a secure session. The customer trusted agent communicates with a first money-module and the supplier trusted agent communicates with the second money-module. The supplier trusted agent delivers the electronic merchandise. The first money module transmits electronic money to the second money module. Upon successful completion of the money payment, the first money module informs the customer trusted agent, and the second money module informs the supplier trusted agent.

The supplier then logs the sale and the customer may use the purchased electronic merchandise.

In U.S. Pat. No. 5,319,542, a system for ordering items using an electronic catalog is disclosed. However, the disclosure is primarily concerned with establishing a private catalog resident on a customer's computer system. The customer can electronically requisition a product based on the information provided in the catalog and route or requisition through the appropriate approval process within the enterprise. However, requisitions must then be processed through the customer's procurement system and transmitted electronically as purchased orders to the supplier. Therefore, aside from establishing private catalogs which may be used by the customer, the system disclosed in the patent does not eliminate many of the inefficiencies and expenses involved with requisitioning products and/or services by many employees in a large organization.

In U.S. Pat. No. 5,592,378, a computerized order entry system and method is disclosed which includes a plurality of servers, data entry devices, back-end systems and data bases. The computer order entry system is intended to permit placement of orders by capturing order information and storing the order information through the data capture mechanism. This is accomplished by a sequence of steps of multiple search categories. The patent does not address the ready accessibility and ease of use by many employees within an organization to requisition goods/services from a pre-arranged trading partner or multiple partners.

From U.S. Pat. No. 6,115,690 another example for an integrated business to business web commerce system is know. The system relies on a computer module based on a single integrated data base management system that is either web-enabled or provided with a web-front-end. The web provides a window into a “seamless” end-to-end internal business process.

It is a primary object of the invention to provide a method, server system and computer program product for efficient handling of the user registration process, in particular with respect to registration in an electronic commerce system, such as a business to business electronic commerce procurement system.

The invention is advantageous in that it allows efficient user registration in combination with a maximum degree of organizational flexibility. Further the invention enables save business transactions with customers who are previously unknown to the on-line merchant.

A particular advantage of the invention is that it seamlessly integrates into an existing organizational structure of a customer. A change in the customer's organizational structure such as the creation of new departments or a merger of existing departments, is readily reflected in the corresponding user registrations. It is a further advantage of the invention to allow different levels of user authorisation, such as authorisation as an administrator or buyer. For example, a registered administrator has the authority to accept or decline application from company employees to obtain a registration.

It is a further advantage of the invention that the administration of user registrations does not require dedicated in-house computer resources at the customer site; rather the customer only requires an access to a computer network, such as the internet, in order to access the server computer of the on-line marketplace for the user registration and administration process.

It is a further advantage of the invention that it allows seamless integration with existing e-commerce platforms, for example utilization of an existing “shopping basket” or “shopping cart” module.

### BRIEF DESCRIPTION OF THE DRAWINGS

These and other features of the invention are described below with reference to the drawings of a computer-based shopping system, which is intended to illustrate and not to limit the invention, and in which:

FIG. 1 illustrates the steps preformed for the initial registration of a user as administrator and a subsequent user registration;

FIG. 2. shows a schematic block diagram of an electronic commerce system;

FIG. 3 shows an enlarged view of the server computer of the electronic commerce system of FIG. 2;

FIG. 4 illustrates the organizational structure of a company which participates in the electronic commerce system;

FIG. 5 illustrates a corresponding database structure of the database comprised in the server of FIG. 3;

FIG. 6 illustrates the steps performed for initializing a company and user registration for the electronic commerce system;

FIGS. 7 and 8 illustrate the steps performed for processing a subsequent application for registration of an additional user;

FIG. 9 illustrated the steps performed for processing an initial application request for a user whose company is already registered; and

FIGS. 10 to 15 illustrate the user interface for entering, viewing and editing of the company and user related data.

### DETAILED DESCRIPTION OF THE PREFERRED EMBODIMENT

Glossary of Terms and Acronyms

The following terms and acronyms are used throughout the detail description:

Client-Server. A model of interaction in a distributed system in which a program at one site sends a request to a program at another site and waits for a response. The requesting program is called the “client”, and the program which responds to the request is called the “server”. In the context of the World Wide Web (discussed below), the client is a “Web browser” (or simply “browser”) which runs on a computer of a user; the program which responds to browser requests by serving Web pages is commonly referred to as a “Web server”.

Hyperlink. A navigational link from one document to another, or from one portion (or component) of a document to another. Typically, a hyperlink is displayed as a highlighted word or phrase that can be selected by clicking on it using a mouse to jump to the associated document or documented portion.

Hypertext System. A computer-based informational system in which documents (and possibly other types of data entities) are linked together via hyperlinks to form a user-navigable “web”. Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols). World Wide Web (“Web”). Used herein to refer generally to both (i) a distributed collection of interlinked, user viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web Site. A computer system that serves informational content over a network using the standard protocols of the World Wide Web. Typically, a Web site corresponds to a particular Internet domain name, such as “IBM.com”, and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

HTML (Hyper Text Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from Web server to a browser, the codes are interpreted by the browser and used to parse and display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc. 1995 (ISBN 0471-11894-4).

HTTP (Hyper Text Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET <URL>, causes the server to return the document of file located at the specified URL.

URL (Uniform Resource Locator). A unique address which fully specifies the location of a file or other resource on the Internet. The general format of a URL is protocol://machine address:port/path/filename. The port specification is optional, and if none is entered by the user, the browser defaults to the standard port for whatever service is specified as the protocol.

PUSH Technology. An information dissemination technology used to send data to users over a network. In contrast to the World Wide Web (a “pull” technology), in which the client browser must request a Web page before it is sent, PUSH protocols send the informational content to the user computer automatically, typically based on information prespecified by the user.

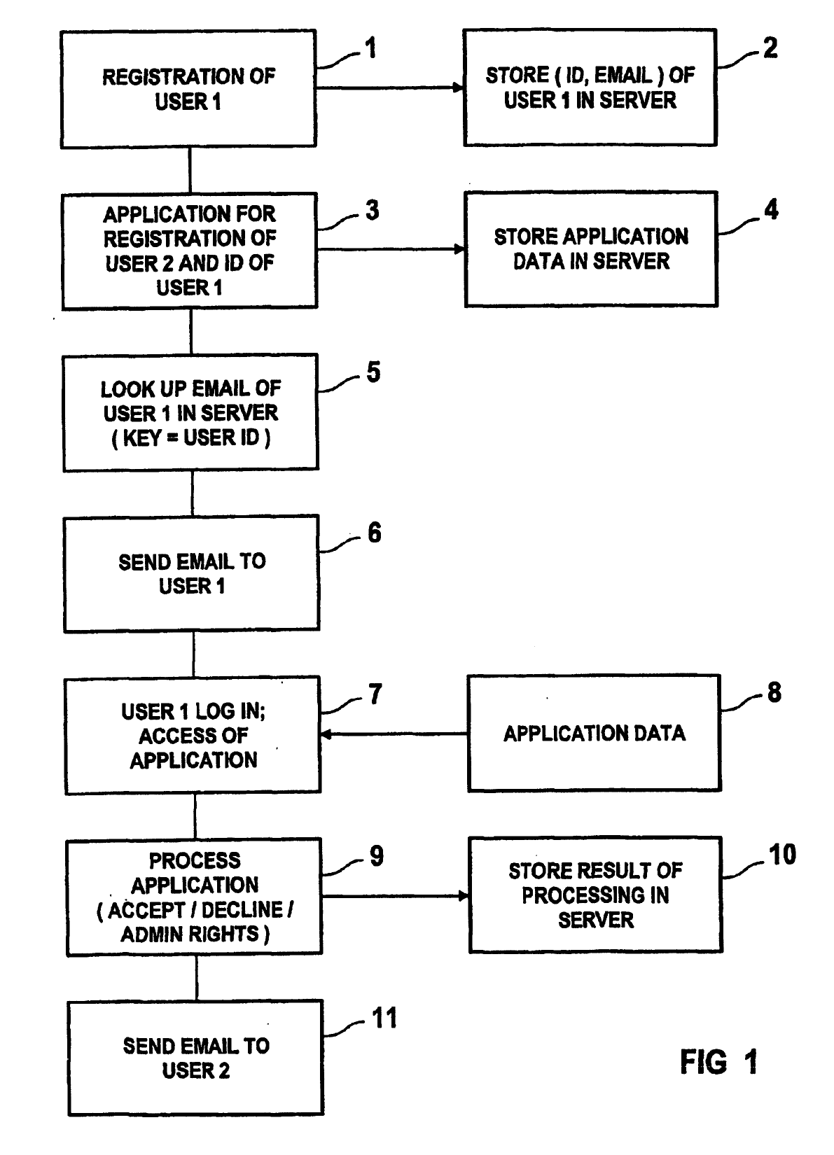

In accordance with the preferred embodiment depicted in FIG. 1 a request for registration of user 1 is made in step 1. The registration request is inputted into a server computer. This triggers the execution of a data processing program in the server computer to assign an identifier to the user 1. The identifier and other data relating to user 1, such as his or her e-mail address, are stored in a database accessible by the server computer in step 2.

In step 3 another user 2 submits an application for user registration. The application request contains data relating to the user 2, such as his or her e-mail address, as well as the identifier assigned to user 1 in step 2. A corresponding application data is stored in the database accessible by the server in step 4. This triggers the execution of a data processing program in the server to retrieve the e-mail address of user 1. The retrieval is performed by using the identifier of user 1 as a key for the database access. This is done in step 5.

In the following step 6 and e-mail message is automatically generated to notify user 1 of an application for user registration which has been made. The e-mail is automatically sent to user 1 by the server computer. Upon receipt of this e-mail message in the in-box of the client computer of user 1 the user 1 logs in the server computer to access the application data of the application submitted by user 2. This is done in step 7.

In step 8 the application data is downloaded from the server to the client computer of user 1. In step 9 the application data is shown on the display of the client computer of user 1. The user 1 reviews the application data and makes a decision regarding the application, for example to accept or decline the application and/or to assign certain rights and authorizations to the desired registration of user 2. This is done in step 9.

After the editing of the user data has been completed and after the user 1 has inputted his or her decision the user 1 sends the resulting data from the client computer to the server. The resulting data is stored in the database accessible by the server computer in step 10. In the example considered here the server retrieves the e-mail address of user 2 from the database in order to generate an e-mail message to the user 2 informing user 2 about the result of the processing of the application for user registration. For example this way the user 2 can be notified about his or her authorization level, such as administrator or buyer. Also if the application is declined this way the user 2 can be informed in step 11.

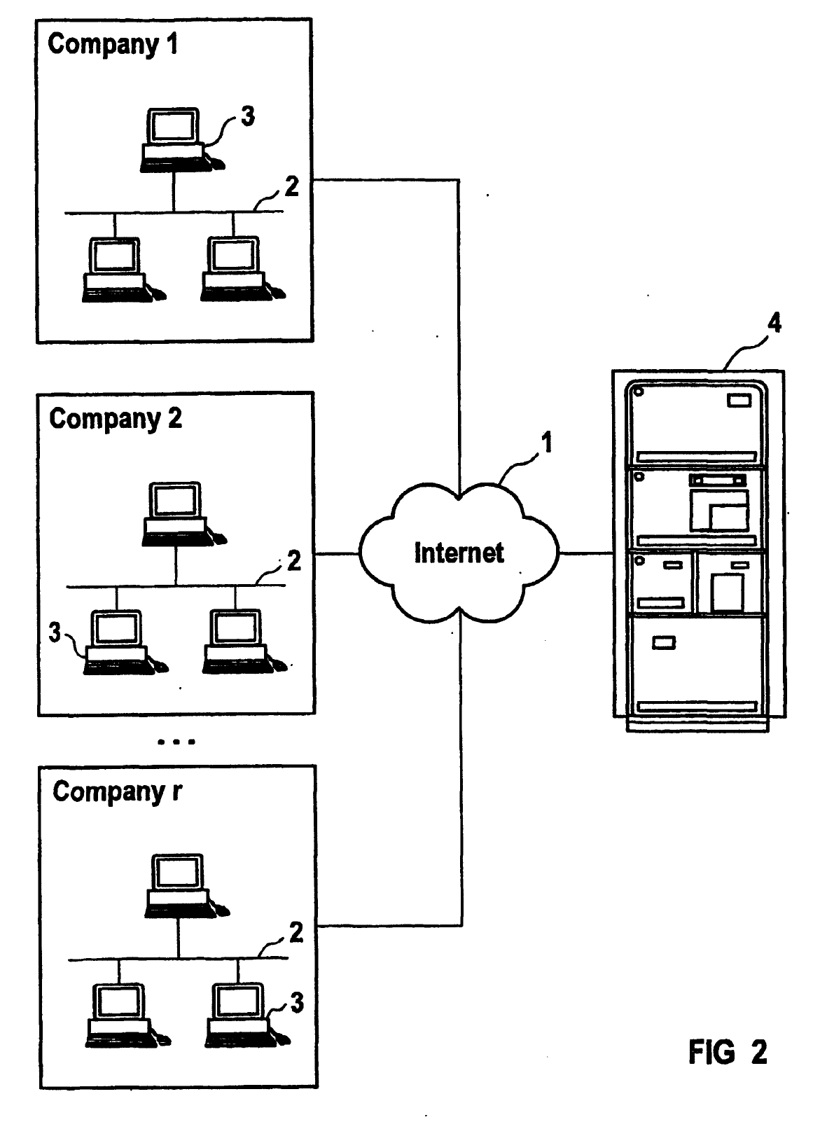

FIG. 2 shows a schematic block diagram of an electronic commerce system. The electronic commerce system relies on a network, such as internet 1, as a communication means between the participants of the electronic commerce system. In the example considered here a number r of companies participate in the electronic commerce system. Each of the companies has an intranet 2. Each intranet 2 has a number of client computers 3 which are accessible to employees of the respective companies.

Each of the intranets 2 is coupled to the internet 1 through a gateway. Server computer 4 is also coupled to the internet 1 such that the server computer 4 can be accessed from each client computer 3 of the different companies.

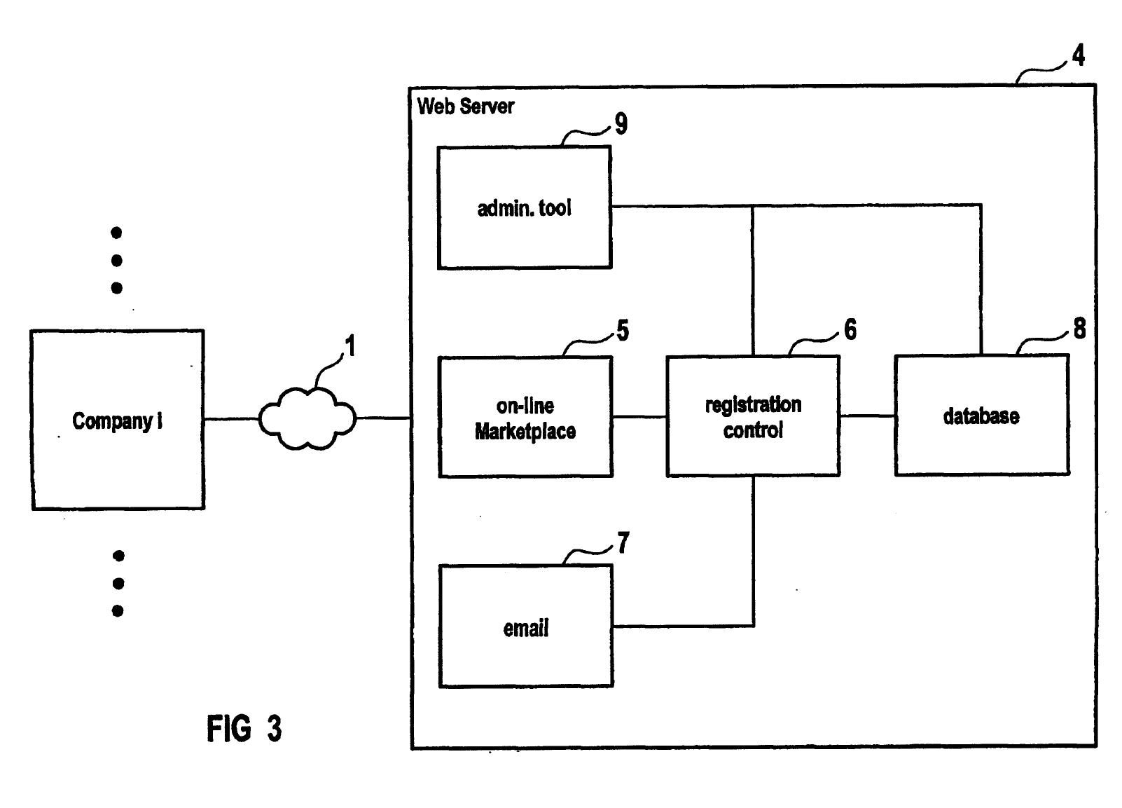

FIG. 3 shows an enlarged view of the server computer 4. The server computer 4 has on-line marketplace 5, such as an on-line shop. The on-line marketplace has an on-line catalogue for viewing and selecting goods and services by customers. Further the on-line marketplace 5 has a virtual shopping basket for storing and viewing customer selected products and services which have not yet been purchased. The on-line marketplace 5 also comprises a payment component for processing the payments for goods and services as well as an interface to an logistics component for order fulfillment.

Before a user can start shopping in the on-line marketplace 5 a prior registration is required. By means of the registration the user obtains at least a user ID and a password. Both the user ID and the password are required to log into the on-line marketplace 5 of the server computer 4.

It is advantageous that also the company to which a user belongs needs to be registered as a prerequisite for accessing the on-line marketplace 5. For example the company i so far has not participated in the electronic commerce system provided by the server computer 4. The company i has a number of employees which can access the server computer 4 via internet 1 through the company's intranet. To participate in the electronic commerce system one of the employees of the company i needs to request his or her registration. This is done by inputting the uniform resource locator of the on-line marketplace 5 in the web browser program of a client computer connected to the intranet of company i. The on-line marketplace 5 prompts the user to register in order to participate in the electronic commerce. Clicking on a corresponding button on the web page of on-line marketplace 5 triggers the execution of a registration control program 6 which is coupled to on-line marketplace 5. The registration control program 6 requires the applicant to enter a variety of data concerning both the company i and the applicant himself. After the required data has been inputted by the applicant the registration control program 6 assigns a applicant ID and a password to the user as well as a further identifier. The further identifier is refered to as “admin ID” in the following. P The registration control program 6 triggers an e-mail program 7 of the server computer 4 in order to automatically generate an e-mail message for the newly registered user to acknowledge successful registration of both the company i and the user. The e-mail message contains the user ID, the password and the admin ID.

The registration control program 6 can also assign an ID to the company i. The company ID as well as the user ID, password, the admin ID and the e-mail address of the newly registered user are entered into the database 8 of the server computer 4 by the registration control program 6. The server computer 4 further has an administration tool 9. By definition the first registered user of company i has administrator status. The administrator can access the contents of database 8 by means of the administration tool 9 after having logged into the on-line marketplace 5. The administration tool 9 allows the administrator to view, edit update and delete any of the application and registration data of database 8.

If an additional employee of the company i desires to become a registered user or administrator for the on-line marketplace 5 he or she needs to access the on-line market 5 via the internet 1 in order to trigger the execution of the registration control program 6 by clicking on a corresponding button of the web page of the on-line marketplace 5.

Again the registration control program 6 requires the applicant to input data. If the applicant has been informed by the company i of the admin ID assigned to the first user which has been registered previously the applicant can enter this identifier in an entry field provided by the registration control program 6. Also the new applicant can enter information concerning his or her company i which allow identification of the company. This can be the company identifier.

After the identifier and the other required data have been inputted by the applicant the registration control program 6 queries the database 8 in order to retrieve the e-mail address of the first user who obtained the admin ID. After retrieval of the e-mail address an e-mail message is automatically generated and sent out by the e-mail program 7 to the administrator with the admin ID. In response to receipt of this e-mail message, the administrator can access the application data through the administration tool 9 of on-line marketplace 5.

By means of the administration tool 9 the administrator can enter a decision regarding acceptance or not of the application. The administrator has various options for making a decision regarding the application: In case the administrator desires to accept the application the applicant can be assigned a buyer-status or administrator-status. If administrator status is assigned by default the same admin ID is used for the additional administrator as for the first administrator. However, it is also possible to request a separate admin ID for the new administrator. This can be advantageous for seamlessly integrating the on-line marketplace 5 into the organizational structure of company i:

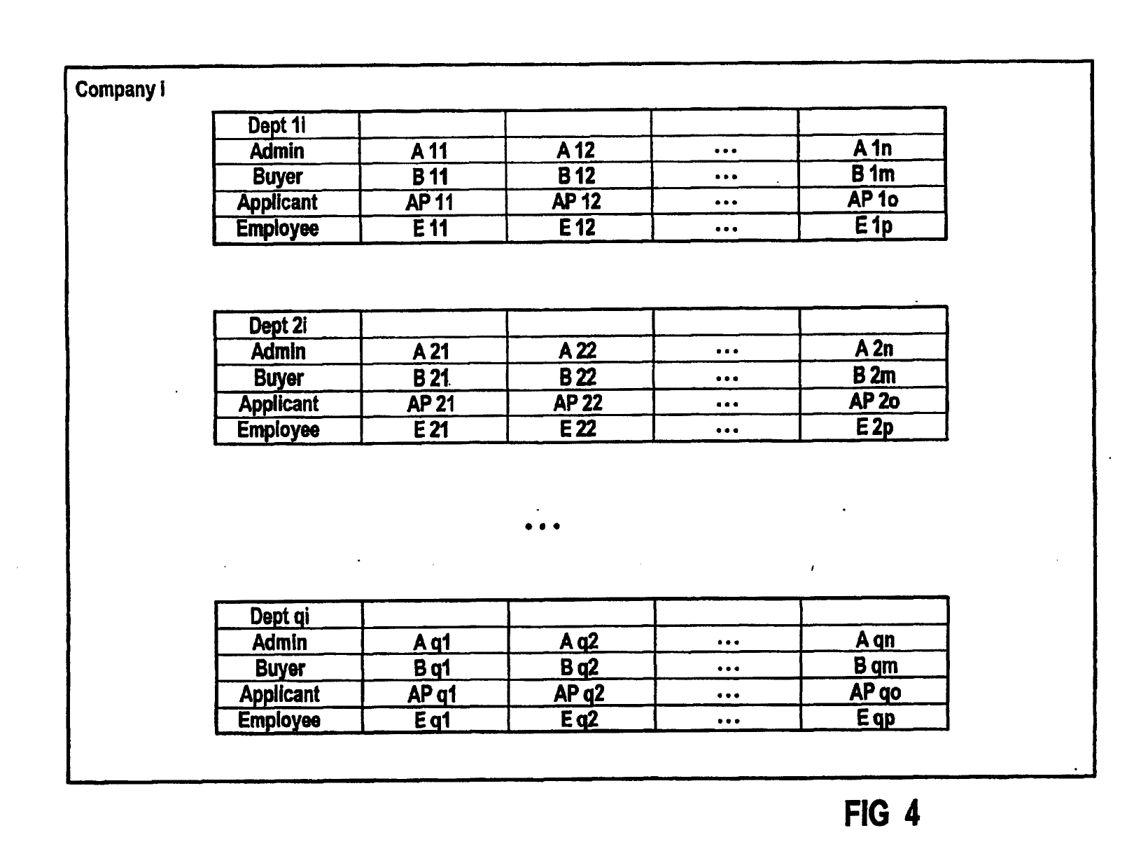

FIG. 4 schematically depicts the internal organizational structure of company i. The company i has a number of q departments Dept 1i, Dept 2i, . . . , Dept qi. Each department has a number p of employees where the number p of employees typically varies from department to department. The employees are designated as Ej1, Ej2, . . . , Ejp where j is the index for the department number. Further each department can have a number n of administrators Aj1, Aj2, . . . , Ajn, where n can be the same or a different number for different departments. Each of the administrators of the same department is supposed to have the same admin ID for access to the administration tool 9 of FIG. 3. Further each department j can have a number m of buyers Bj1, Bj2, . . . , Bjm as well as a number o of applicants APj1, APj2, . . . , APjo.

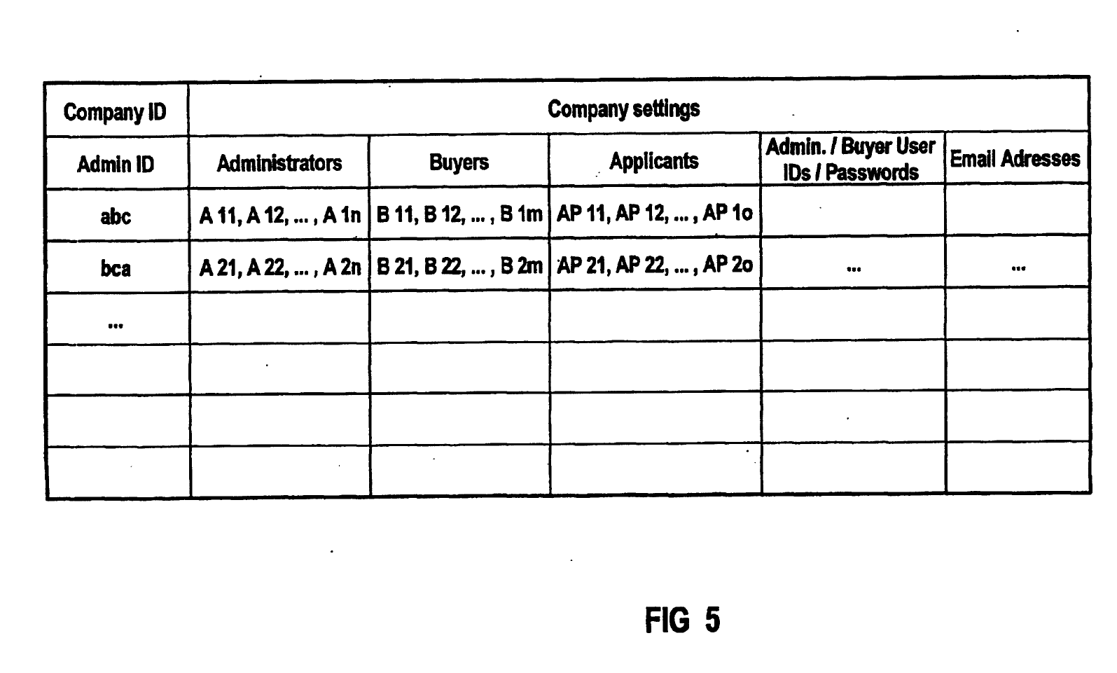

FIG. 5 illustrates the corresponding structure of the database 8 of the embodiment of FIG. 3 after a number of users—both administrators and buyers—have been registered for the on-line marketplace 5 of FIG. 3. The database contains a company ID which is a unique identifier for the company i. Furthermore the database contains company specific information in field “Company settings”.

Further the database contains an identifier—“admin ID”—for each set of administrators Ajl, Aj2, . . . , Ajn belonging to the same department j of the company i. Likewise the database contains information relating to the administrators, buyers and applicants. In particular the field for applicants contains application data which has been entered by an applicant AP for later access by an administrator. Further the data base contains user IDs and passwords for all registered users as well as corresponding e-mail addresses.

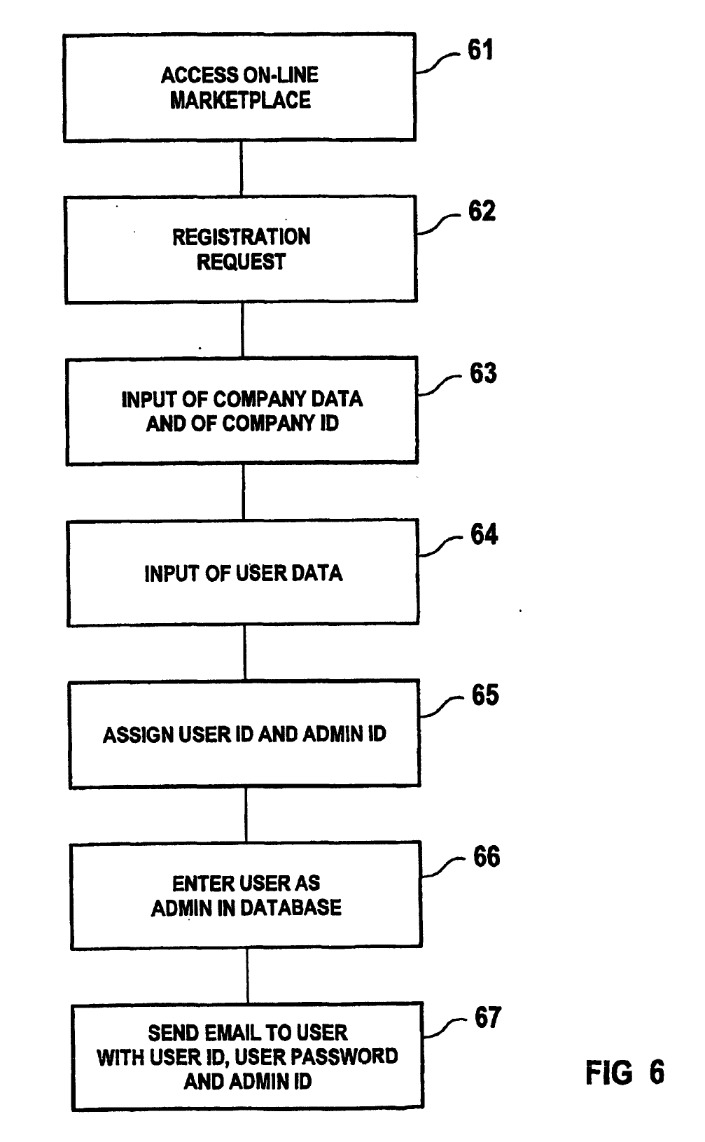

FIG. 6 illustrates the steps to be performed for the initial registration of the company i by one of its' employees. In step 61 the employee of company i accesses the on-line marketplace 5 (cf. FIG. 3). In step 62 the employee submits a request to become a registered user which triggers the registration control program 6. In step 63 the registration control program 6 prompts the user to input company specific data and an unique company ID. For example the VAT-Number of the company i can be utilized as an unique identifier or the DUNS-Number of the company i. The DUNS (a unique number assigned by Dun & Bradstreet Corp.) number can be validated using Dun & Bradstreet Corp. Modulus Ten Check Digit™. algorithm for the ninth digit.

In the next step 64 the user is prompted to input user specific data, such as the user's name, telephone number, fax number and e-mail address.

In step 65 a user ID and an admin ID are assigned to the employee of the company i. This is done by the registration control program 6 as explained with reference to FIG. 3 above.

In step 66 the employee is entered as a user with administrator status in the database together with the data which has been inputted in the previous steps 3 and 4. For example—also referring to the database structure depicted in FIG. 5—the admin ID assigned to the user in step 5 is “abc”. This admin ID is entered into the database 20 as well as the administrator All and further information related to the administrator such as his or her user ID, password and e-mail address.

In step 67 an e-mail is sent to the user as an acknowledgement. It is advantageous that this e-mail contains the admin ID, user ID and password as well as the data which the user has entered in the registration application process for information and verification.

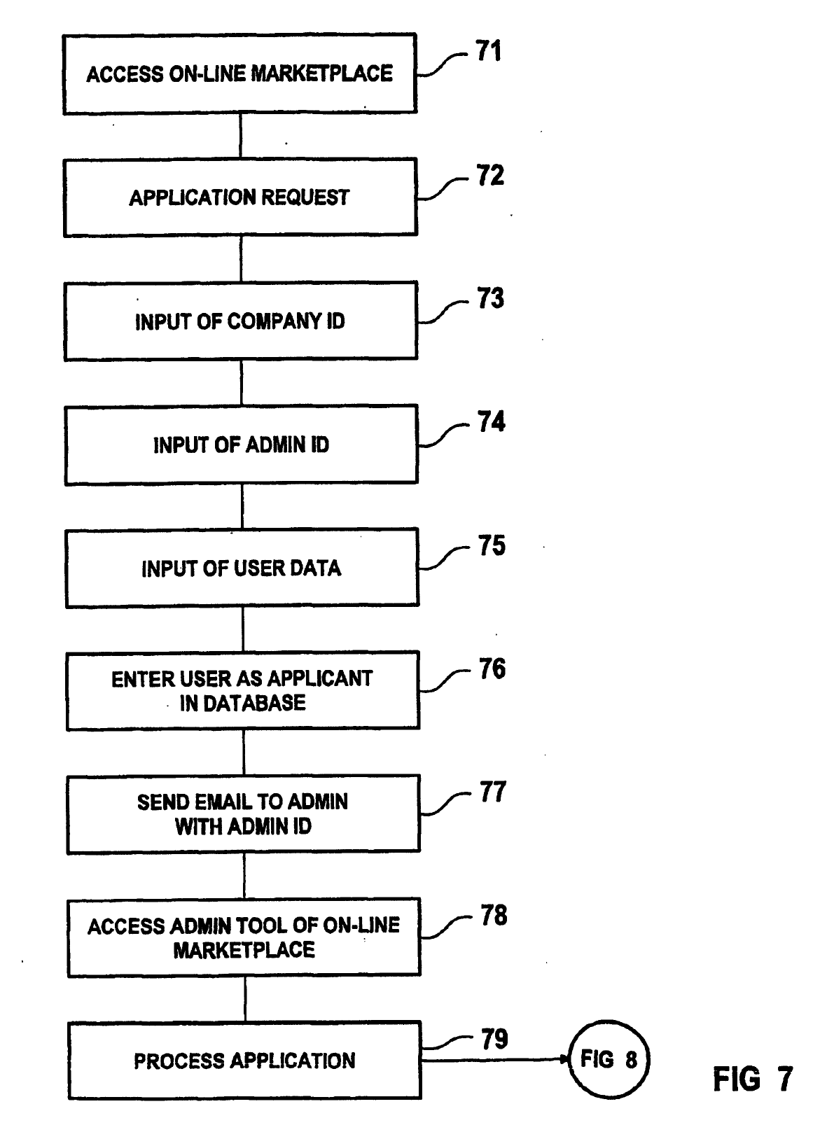

With respect to FIG. 7 now the data processing steps for processing the application of an employee of the company i are illustrated—assuming that the company i already has at least one administrator with the identifier “admin ID”. In step 71 the employee of the company i connects to the on-line marketplace by connecting to the web server via the internet and downloading of a corresponding web page onto his or her client computer.

In step 72 the employee triggers the start of the registration control program by clicking on a button shown on the web page for requesting an application for registration as a user. By means of a so called PUSH operation the registration control program sends an input form to the client computer of the employee.

In step 73 the employee inputs the company ID into the form. The company ID is a unique identifier. After the inputting of the company ID into the corresponding form field the employee clicks on the submit button of the form. By a subsequent PUSH operation the registration control program provides another form to the client computer of the employee.

In step 74 the employee enters the admin ID of the administrator. In step 75 the employee enters his user data, such as his name, telephone number, fax number and e-mail address. Then the user clicks on the submit button of the form so that the application data inputted by the employee in steps 73 and 74 is sent to the server computer.

In step 76 the application control program of the server performs a database access in order to write the application data to the corresponding database fields. This is done using the company ID and the admin ID as keys for identifying the correct storage location within the database.

Likewise the company ID and the admin ID which have been inputted in steps 73 and 74 are used as keys to retrieve the e-mail address of the administrator having the admin ID from the database by the registration control program.

In step 77 the registration control program invokes the e-mail program to sent an e-mail to the administrator with the admin ID. By way of the e-mail message the administrator is informed about the receipt of an application for user registration of an employee of the company i. The e-mail message is received in the in-box of the client computer of the administrator. In response to the receipt of the e-mail message the administrator connect to the web in order to access the on-line marketplace. Through the top-level window of the on-line marketplace the administrator can request access to the administration tool. This requires the administrator to input his or her password and user ID. The user ID of the administrator can be the same as the admin ID. However it is advantageous that the user ID of the administrator and the corresponding admin ID be different for improved control and security of the registration system.

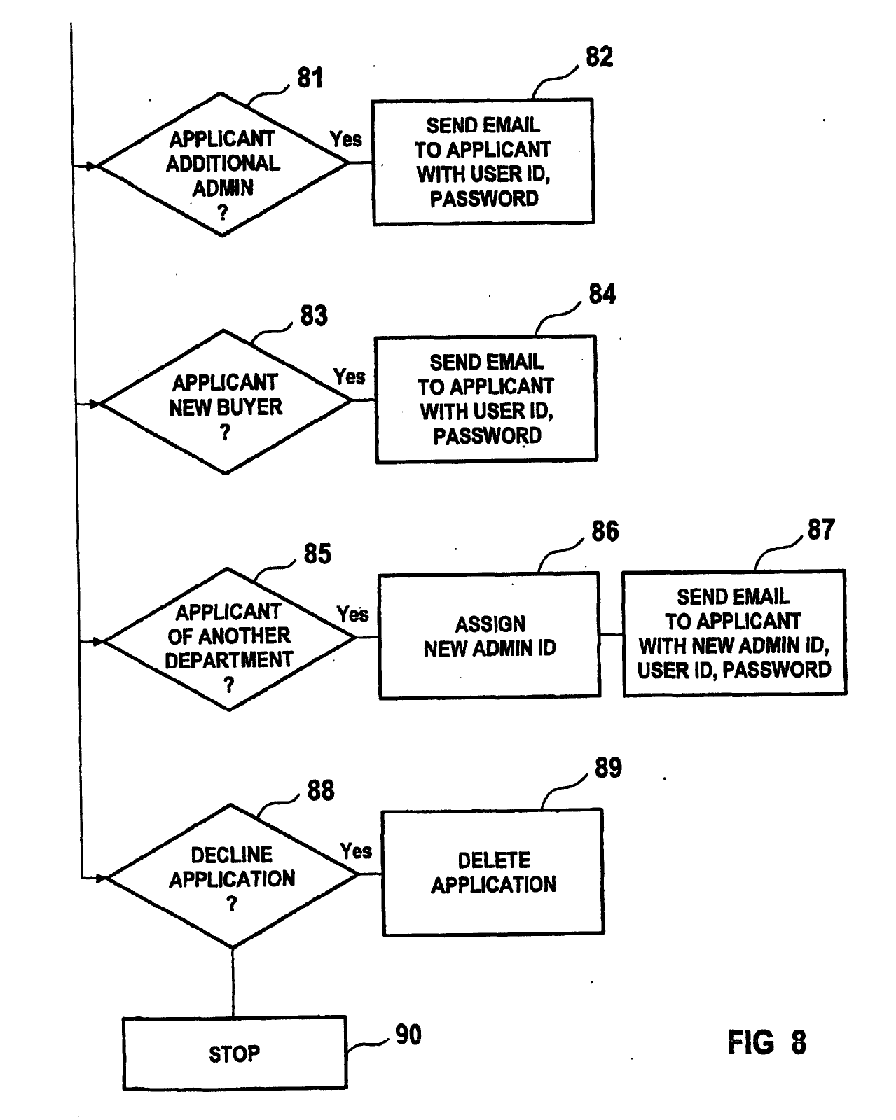

In step 78 the administrator is given access to the administration tool of the on-line marketplace. The administration tool performs an access operation to the database in order to retrieve the application data of the application in response to which an e-mail was previously sent to the administrator by the registration control program in step 77. This can be done by retrieving all pending application data which has been previously inputted with the admin ID of the administrator. For example—also referring to FIG. 5—if the application data AP11 and AP12, has been inputted with admin ID “abc” these pending applications AP11 and AP12 are retrieved by the administration tool from the database when the administrator with the admin ID “abc” logs in to the system. The processing of the application data in step 79 is shown in more detail in FIG. 8.

The administrator is given a variety of options for the processing of the application data. In step 81 the option is to accept the employee as an additional administrator with the same admin ID “abc”. If the administrator takes this decision and clicks on a corresponding field or button displayed on the web site this triggers the administration tool to send an e-mail to the applicant to inform him or her about this decision in step 82.

In step 83 the administrator can take the decision to accept the applicant as a new buyer. Buyer-status means that the applicant will be registered as a user who can purchase on the on-line marketplace on behalf of the company i. However buyer-status does not give access permission to the administration tool. Inputting of this decision by the administrator triggers sending of a corresponding e-mail to the applicant in step 84.

In step 85 the administrator can identify the applicant to belong to another department of the company i. When the administrator with the admin ID “abc” enters such a decision this implies that (i) the applicant is accepted as a registered user and (ii) is given administrator status but with another admin ID. A new admin ID is assigned to the applicant in step 86 by the registration control program which is triggered by the administration tool. In step 87 an e-mail is sent to the applicant containing the new admin ID, the user ID and password of the new registered administrator.

In step 88 the administrator can decide to decline the application. If the administrator enters this decision the application data is deleted from the database by the administration tool in step 89. Before the operation stops in step 90 the database is updated correspondingly to reflect an acceptance of the applicant and the status assigned to the registration.

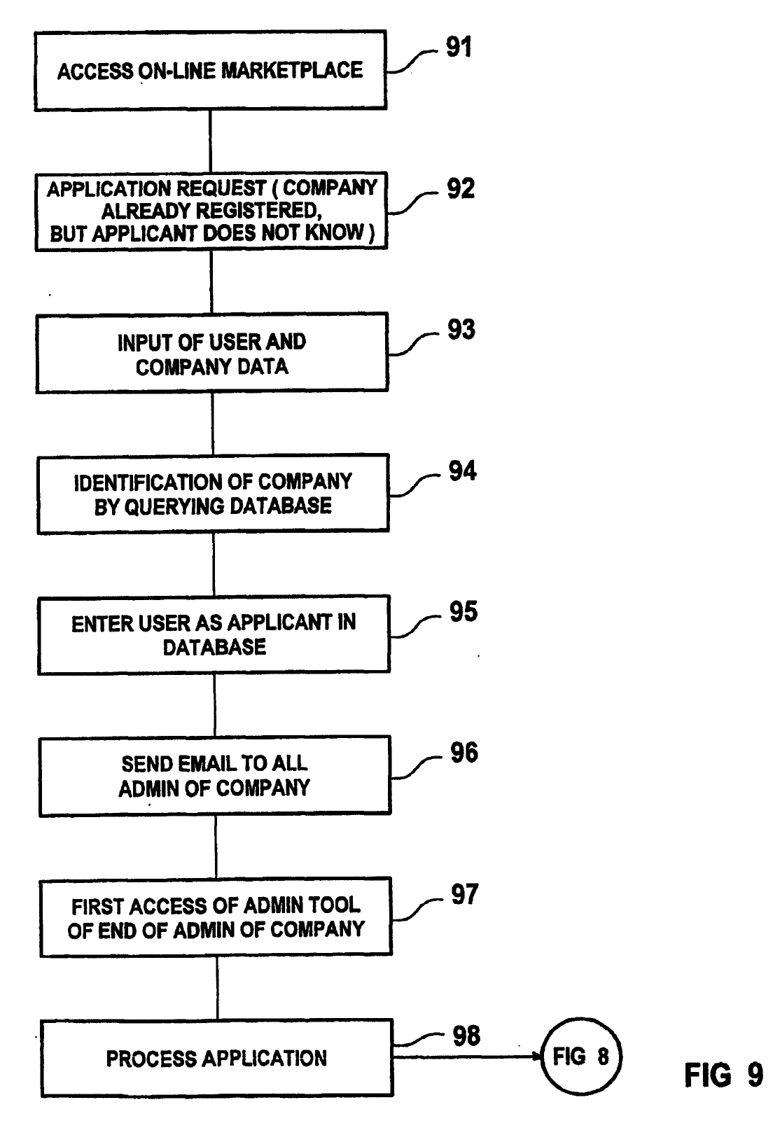

FIG. 9 illustrates the steps performed when an employee of the company i requests registration in case the employee is not aware that the company i has already a registered administrator and admin ID. In step 91 the employee accesses the on-line marketplace via the internet. In step 92 the employee triggers the registration control program by making a corresponding input operation. In step 93 the employee inputs his user data and company specific data—but not necessarily the company ID and not the admin ID.

In step 94 the registration control program queries the database in order to find a best match for the company specific data inputted in step 93.

If the user knows the company ID of the company i the company ID is used as a key.

In step 95 the application data is inputted into the database in a field which is associated with the company i.

In step 96 an e-mail message is sent to all administrators of the company i as the applicant was unable to specify the admin ID. In step 97 one of the administrators of the company i logs into the system to access the administration tool. The processing of the application in step 98 can be done in the same way as described with reference to FIG. 8.

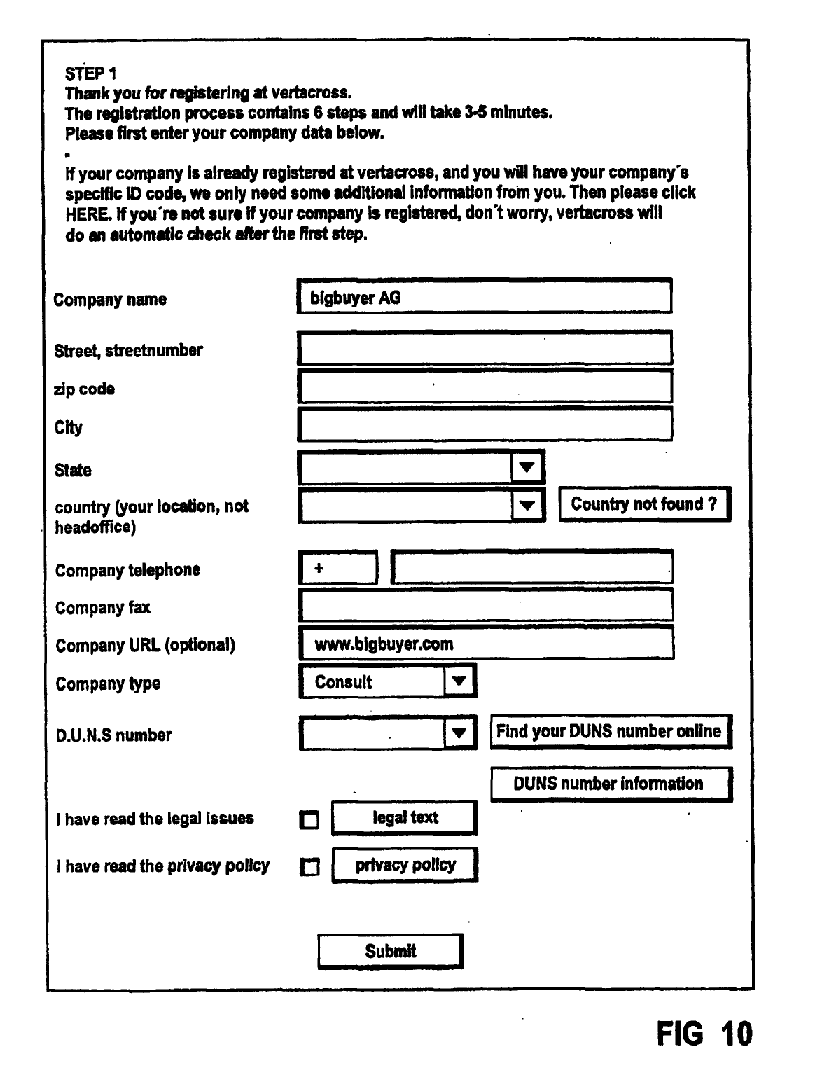

FIG. 10 shows the input form provided to an applicant from the registration control program via the internet. If the company i of the applicant is already participating in the on-line marketplace it is sufficient to enter the company ID in this form. For additional security and control the applicant can be requested to enter some additional company specific data which can be compared against corresponding data of the company ID stored in the database, for consistency.

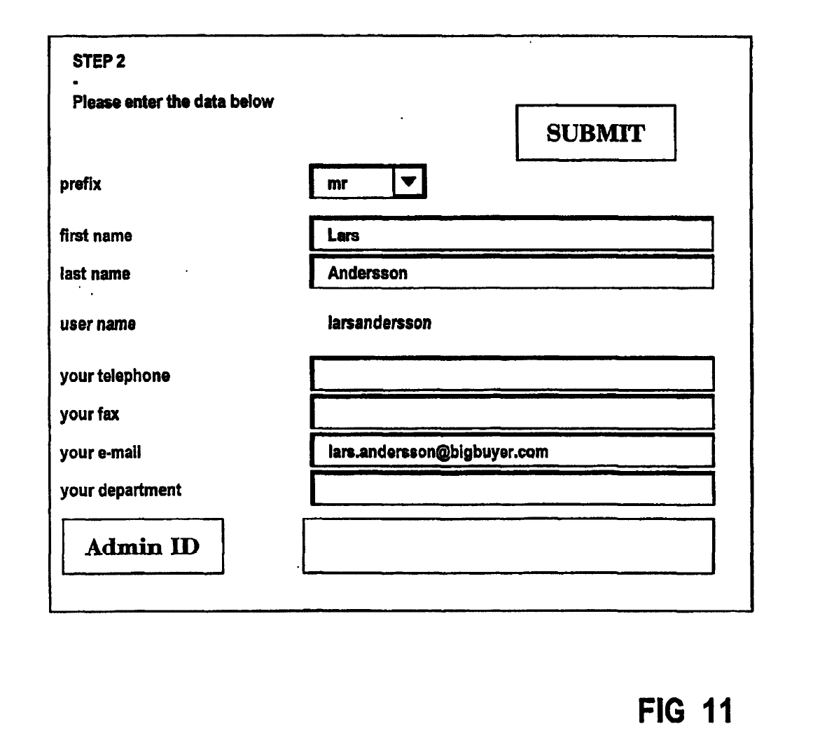

The VAT-Number of the company i can be used as a unique identifier; alternatively the DUNS number can be used as a company ID. After having entered the required information in the form the applicant clicks on the submit button so that the information is provided to the registration control program. In response to this the registration control program triggers a PUSH operation so that the window as depicted in FIG. 11 is shown to the user. In this form the applicant is requested to enter personal data, such as his name, telephone, fax, e-mail and the department for which he or she works. Further the form contains a field allowing to input the admin ID. In the example considered here Mr. Lars Andersson is the applicant AP11 of the company i having an administrator All and A12 with admin ID “abc” (cf. FIGS. 4 and 5).

The applicant Lars Andersson is supposed to enter the admin ID “abc” into the field. However, if Mr. Andersson in fact belongs to another department of the company i which does not have an administrator and a corresponding admin ID he can still input the admin ID “abc” of the department li. After having inputted the required data Mr. Andersson clicks on the submit button such that the data is sent to the registration control program.

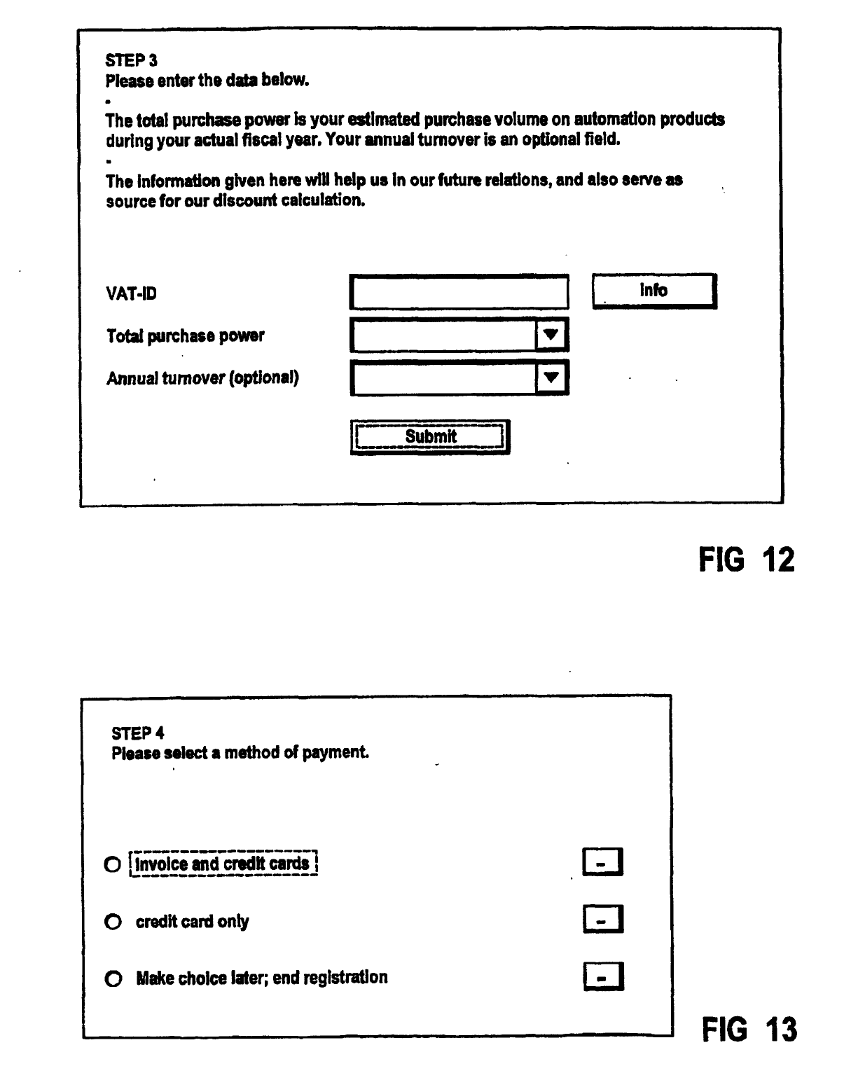

This again triggers a PUSH operation of the registration control program such that the window of FIG. 12 is shown to Mr. Andersson for inputting of additional financial data. Next the method of payment is specified in the window depicted in FIG. 13. All the data which is inputted by Mr. Anderson in the windows of FIGS. 10 to 13 is inputted into the database by the registration control program.

Next an e-mail is sent to the administrator or to the group of administrators having the admin ID “abc” which Mr. Andersson has inputted as part of the application data. For example Herr Helmut is the administrator A12 of the department ii of company i. When Herr Helmut accesses the administration tool he is shown the window as depicted in

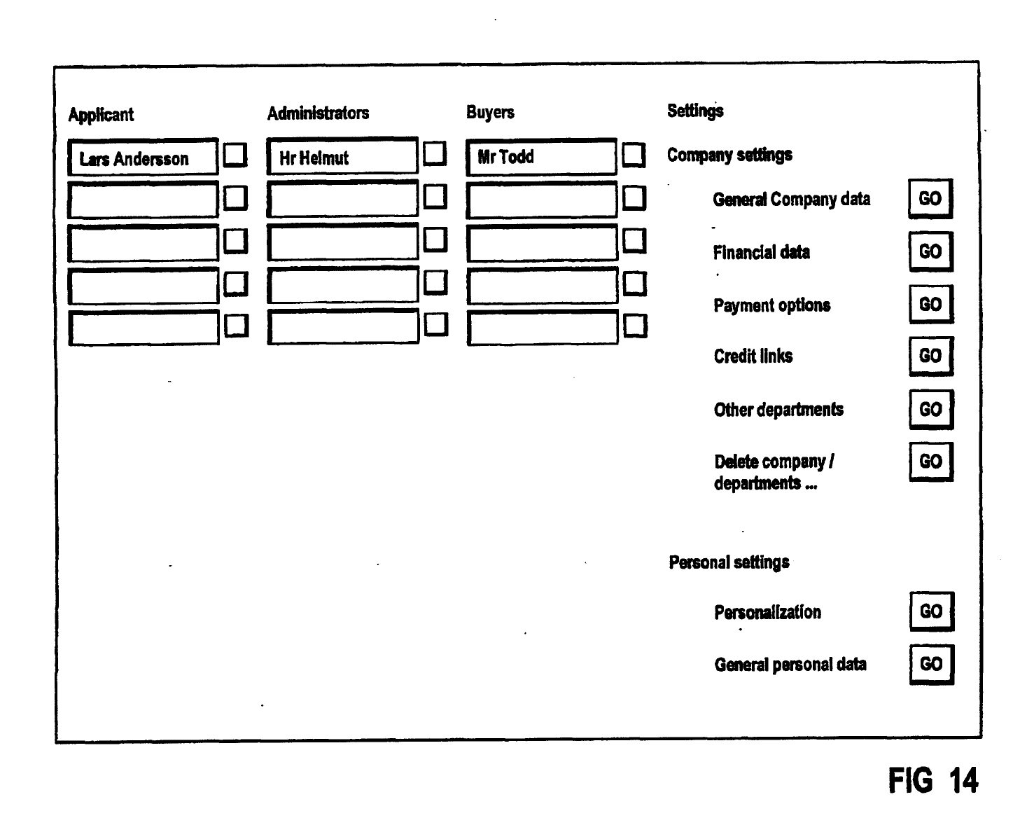

FIG. 14. The window contains a column for the pending applications, the administrator and the registered buyers of the department li. In the example considered here Mr. Andersson is shown as the applicant; Mr. Todd is shown to be a registered buyer B11. When Mr. Helmut clicks on the button next to “Lars Andersson” this triggers the processing of the application data of this application. Alternatively Herr Helmut can also access and edit other data relating to company settings and personal settings as depicted in FIG. 14 by clicking on one of the GO buttons.

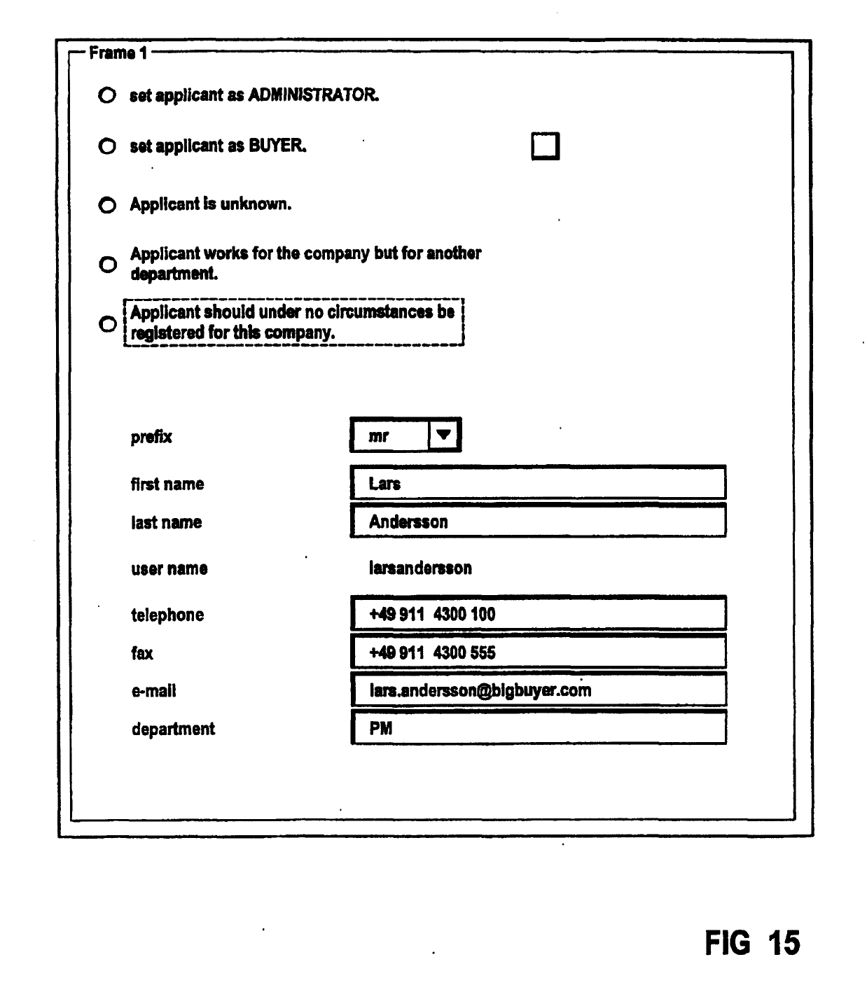

When Herr Helmut clicks on the button to invoke the processing of the application data of Mr. Andersson the window as shown in FIG. 15 is displayed on the screen of Herr Helmut. This windows shows the application data of Mr. Andersson and contains a number of options for processing the application. A first option for Herr Helmut is to “set applicant as administrator”.

Accepting Mr. Andersson as administrator means that Mr. Larson has the rights of a registered buyer and at the same time has the right to access the administration tool. The admin ID assigned to Mr. Andersson in this case is the same as the admin ID of Herr Helmut which is “abc”. This implies that both Herr Helmut and Herr Andersson belong to the same department li.

Alternatively Herr Helmut can select the option “set applicant as buyer” such that Mr. Andersson becomes a registered user without administrator status and thus no access permission to the administration tool.

Another option is to inform the on-marketplace that the applicant is unknown. In this case it is up to the on-line marketplace to further process the application or not, for example by directly contacting the applicant.

Selecting the following option “applicant works at the company but for another department” implies acceptance of Mr. Andersson as a registered user with administrator status of another department. In this case another admin ID is assigned to Mr. Andersson, such as “bca”.

Finally Herr Helmut has the option to click on “applicant should under no circumstances be registered for this company” in case the applicant is suspect.

1. A method for processing of an application for registration as a user comprising the steps of:
a) submitting of application data to a server computer, the application data comprising an identifier of a registered user;
b) sending an electronic message to the registered user;
c) accessing of the application data by the registered user; and
d) entering of the registered user's decision regarding the application.

2. The method of claim 1 further comprising submitting an identifier of the commercial entity to which the registered user belongs.

3. The method of claim 1 or 2 further comprising retrieving an electronic mail address of the registered user from a database using the identifier of the registered user as a key.

4. The method of claim 1, 2 or 3 further comprising in case of an acceptance of the application entering of an user authorisation level into a database accessible by the server.

5. The method of claim 4 the user authorisation level comprising administrator or buyer status.

6. The method of claim 5 the applicant and the registered user belonging to the same commercial entity, the applicant belonging to a first organization of the commercial entity and the registered user belonging to a second organization of the commercial entity, the method further comprising:
a) inputting of data indicative of an acceptance of the applicant by the registered user;
b) assigning a second identifier to the applicant; and
c) sending an electronic message to the applicant comprising the second identifier.

7. A method for processing of an application for registration as a user belonging to a commercial entity, the commercial entity having a number of registered users, the method comprising the steps of:
a) submitting of application data to a server computer, the application data comprising data for identification of the commercial entity;
b) sending an electronic message to the registered users;
c) accessing of the application data by one of the registered users; and
d) entering of the registered user's decision regarding the application.

8. The method of claim 7 further comprising the step of querying a database of a server computer for finding a best match for the data for identification of the commercial entity for retrieval of the commercial entity and access to the addresses of the registered users of the commercial entity.

9. A server system comprising
a) means (5,6) for receiving of application data for registration as a user;
b) database means (8) for storing the application data;
c) means for retrieval (6,8) of an electronic mail address of a registered user;
d) means (7) for sending an electronic message to the registered user;
e) means (8,9) for providing access to the application data for the registered user;
f) means (9) for entering of the registered user's decision regarding the application.

10. The server system of claim 9, the application data comprising an identifier of the registered user, the identifier serving as a key for the retrieval of the electronic mail address.

11. The server system of claim 9 or 10, the application data comprising data for identification of a commercial entity, the data for identification of the commercial entity serving as a basis for the retrieval of the electronic mail address.

12. The server system of claim 11 further comprising means for sending an electronic message to all registered users of the commercial entity in response to the reception of the application data.

13. The server system of any one of the claims 9 to 12, the database means assigning the identifier to a first set of administrators, to a second set of registered users having a buyer status and to application data, if any.

14. The server system of any one of the claims 9 to 13 further comprising means for authenticating a registered user.

15. The server system of any one to the claims 9 to 14 further comprising means for editing the data of the database means for registered users having an administrator status.

16. The server system of any one to the claims 9 to 15 further comprising an on-line marketplace component.

17. An electronic commerce system comprising a server system (4) according to any one of the claims 9 to 16 and a plurality of client systems (3), the server system and the plurality of client systems being coupled by a computer network (1).

18. A computer program product stored on a computer usable medium, comprising computer readable program means for causing a client computer to perform a method according to any one of the preceding claims 1 to 8.
